(19) United States
(12) Patent Application Publication
(10) Pub. No.: US 2007/0172374 A1
(43) Pub. Date: Jul. 26, 2007

(54) Expander

(75) Inventors: Hiroshi Hasegawa, Osaka (JP); Atsuo Okaichi, Osaka (JP); Fumitoshi Nishiwaki, Hyougo (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: Matsushita Electric Industrial Co., Ltd., Kadoma-shi (JP)

(21) Appl. No.: 10/590,383

(22) PCT Filed: Feb. 17, 2005
(86) PCT No.: PCT/JP05/02955

§ 371 Date: Aug. 23, 2006

(30) Foreign Application Priority Data
Feb. 24, 2004 (JP) 2004-047372

(51) Int. Cl. F16N 13/20

(52) U.S. Cl. 418/63

(57) ABSTRACT

A cylinder 2, a roller 4, an upper bearing member 7 and a lower bearing member 8 form a space, the space is partitioned by a vane 5 into working chambers 12. Working fluid is sucked into the working chamber 12 through a suction hole 7c, the working fluid is expanded in the working chamber 12 whose volume is varied by rotation, and the working fluid is discharged from a discharge hole 2b into a discharge space 20. A differential pressure regulating valve 21 which is opened when pressure in the working chamber 12 is higher than pressure in the discharge space 20 is provided in the discharge hole 2b. With this, repressing can be carried out even if excessive expansion of working fluid is generated. Therefore, excessive expansion loss can be prevented.

### TECHNICAL FIELD

The present invention relates to an expander as a prime motor for which is operated by high pressure compressible fluid to generate rotation power.

### BACKGROUND TECHNIQUE

Conventionally, as an expander used for a heat pump cycle, there is a rotary expander as disclosed in patent document 1.

The structure of the expander will be explained. FIG. 16 is a vertical sectional view of the conventional expander. FIG. 17 is a transverse sectional view of the conventional expander taken along the line Z-Z in FIG. 16. For the sake of convenience of explanation, an axial passage 3b and a radial passage 3c of a shaft 3, as well as a suction passage 7b and a suction hole 7c of an upper bearing member 7 are shown with broken lines.

The expander comprises a container 1, a cylinder 2, the shaft 3 having an eccentric portion 3a, a roller 4 which eccentrically rotates in the cylinder 2, a vane 5 which reciprocates in a vane groove 2a, a vane spring 6, the upper bearing member 7 and a lower bearing member 8 for supporting the shaft 3, a suction pipe 9 for sucking working fluid, and a discharge pipe 10 for discharging the working fluid.

A working chamber 12 partitioned by the vane 5 is formed between the cylinder 2, the roller 4, the upper bearing member 7 and the lower bearing member 8. The upper bearing member 7 includes a suction space 7a, a suction passage 7b, and a suction hole 7c which serves as an opening on the side of the working chamber 12 of the suction passage 7b. The shaft 3 includes the axial passage 3b and the radial passage 3c. The cylinder 2 is provided with a discharge hole 2b for discharging working fluid into the discharge space 20 from the working chamber 12.

Next, the operation of the expander will be explained. FIGS. 18(a) to (d) show the operation of the expander, and correspond to sectional views taken along the line Z-Z in FIG. 16.

As shown in FIG. 16, the high pressure working fluid flows from the suction pipe 9 into the radial passage 3c of the shaft 3 through the suction space 7a and the axial passage 3b of the shaft 3. The radial passage 3c of the shaft 3 is shaped such that the radial passage 3c opens only a certain angle range of an outer peripheral surface of the shaft 3 as shown in FIG. 18, and forms flow-in timing control means which repeatedly establishes communication state and non-communication state between the radial passage 3c and the suction passage 7b of the upper bearing member 7 as the shaft 3 rotates.

When the radial passage 3c and the suction passage 7b are brought into communication with each other, working fluid is sucked into the working chamber 12 from the radial passage 3c through the suction passage 7b and the suction hole 7c.

The operation of the expander will be explained based on the working chamber 12. FIG. 18(a) shows a state immediately before the intake stroke. From this state, if the shaft 3 rotates in a counterclockwise direction, the radial passage 3c of the shaft 3 and the suction passage 7b of the upper bearing member 7 are brought into communication with each other, the flow-in timing control means is opened, and the intake stroke in which the high pressure working fluid flows into the working chamber 12 is started.

FIG. 18(b) shows a state after the shaft 3 rotates in the counterclockwise direction. In this state, the communication between the radial passage 3c of the shaft 3 and the suction passage 7b of the upper bearing member 7 is cut off, and this state is created immediately after the flow-in timing control means is closed, i.e., the intake stroke is completed.

The volume of the working chamber 12 at that time is a suction volume Vs of the expander. Then, the high pressure working fluid sucked into the working chamber 12 enters the expansion stroke where the working fluid is expanded and decompressed while rotating the shaft 3 in a direction increasing the volume of the working chamber 12, and the state is shifted to a state shown in FIG. 18(d) through FIG. 18(c).

This state is a state immediately before the working chamber 12 is brought into communication with the discharge hole 2b, and at that time, the volume of the working chamber 12 is a discharge volume Vd of the expander. Then, if the shaft 3 is slightly rotated, the working chamber 12 comes into communication with the discharge hole 2b, and the discharge stroke is started.

As the volume of the working chamber 12 is reduced, the working fluid is discharged into the discharge space 20 from the discharge hole 2b. A low pressure working fluid accumulated in the discharge space 20 is discharged outside from the expander through the discharge pipe 10.

As apparent from the above explanation, according to the expander of this structure, the shift from the intake stroke to the expansion stroke depends on the opening and closing of the flow-in timing control means. Therefore, it is found that the flow-in timing control means is an essential constituent element. Examples of the flow-in timing control means other than the above structure are shown in patent documents 2, 3 and 4. A rotary expander repeats the states shown in FIGS. 18(a) to (d), working chambers 12 generated one after another rotate the shaft 3 in a direction increasing the volume in the expansion stroke, and the rotation power is taken out.

An example in which the expander is used for a heat pump cycle will be explained. FIGS. 19 show conception diagrams and Mollier diagram of a heat pump cycle in which carbon dioxide is used as the working fluid. FIG. 19(a) shows a normal heat pump cycle, FIG. 19(b) shows a heat pump cycle utilizing an expander and FIG. 19(c) is a Mollier diagram.

The normal heat pump cycle shown in FIG. 19(a) comprises a compressor 13, a gas cooler 14, an expansion valve 15 and an evaporator 16. The compressor 13 is driven by a driving element 17 such as a motor. The Mollier diagram in this case corresponds to ABCD in FIG. 19(c).

Whereas, in the heat pump cycle utilizing the expander shown in FIG. 19(b), an expander 18 is used instead of the expansion valve 15, a shaft of the expander 18 is directly connected to the shaft of the compressor 13 through the driving element 17. If a fact that the expansion stroke of the working fluid in the expander 18 is approximately adiabatic expansion is taken into consideration, the Mollier diagram in this case is ABCD′ in FIG. 19(c).

By employing such as a heat pump structure, the rotation power collected in the expansion stroke of the working fluid by the expander 18 assists the driving operation of the compressor 13 so that a load of the driving element 17 can be reduced, and enthalpy difference of the evaporator 16 is increased at a portion corresponding to DD′ on the Mollier diagram, and the refrigeration ability can be enhanced.
(Patent Document 1)

Japanese Patent Application Laid-open No.H8-82296
(Patent Document 2)

Japanese Patent Application Laid-open No.H8-338356
(Patent Document 3)

Japanese Patent Application Laid-open No.2001-153077
(Patent Document 4)

Japanese Patent Application Laid-open No.2003-172244

In the conventional expander having the above structure, the suction volume Vs and the discharge volume Vd are determined by the flow-in timing control means and the discharge hole and thus, each apparatus has a peculiar volume ratio (Vd/Vs). If an adiabatic exponent of the working fluid is defined as κ, the pressure in the working chamber 12 when the expansion stroke is started is defined as Ps, and the pressure in the working chamber 12 when the expansion stroke is completed is defined as Pd, the following relation is established:

$$Pd = {( \frac{Vs}{Vd} )}^{κ} Ps \qquad ( Equation 1 )$$

From this equation, the pressure Pd when the expansion stroke is completed is determined by pressure when the expansion stroke is started, i.e., by the suction pressure Ps, the volume ration (Vd/Vs) and the adiabatic exponent κ.

In the heat pump cycle using the expander shown in FIG. 19(b), pressure in the gas cooler 14 is defined as Ph and pressure in the evaporator 16 is defined as Pl. Here, Ph and Pl are determined by the peripheral temperature of the evaporator 16 and a heat exchange amount between the working fluid and air. Therefore, Ph and Pl are varied depending upon peripheral environment where the heat pump is installed. Since the working fluid which flows out from the gas cooler 14 is sucked into the expander 18 as it is, the suction pressure Ps of the expander 18 is equal to pressure Ph of the gas cooler 14. Discharge pressure Pd of the expander 18 is given by (equation 1), and is a function of Ps. Therefore, the discharge pressure Pd is not always equal to Pl, and normally Pd>Pl or Pd<Pl. A case of Pd=Pl is called complete expansion, a case Pd>Pl is called incomplete expansion, and a case Pd<Pl is called excessive expansion.

FIGS. 20 are a PV diagram of the expander 18. FIG. 20(a) shows the incomplete expansion (Pd>Pl), and (b) shows the excessive expansion (Pd<Pl).

The incomplete expansion shown in FIG. 20(a) will be explained.

During the intake stroke, working fluid is sucked until the volume of the working chamber 12 becomes equal to Vs under the pressure Ps (=Ph). In the drawings, it corresponds to AB. During the expansion stroke, the volume of the working chamber 12 is increased from Vs to Vd and with this, the pressure of the working fluid is reduced from Ps to Pd. In the drawing, it corresponds to BC. During the discharge stroke, the working chamber 12 of the pressure Pd is are brought into communication with the discharge hole 2b, and the working fluid flows out into the discharge space 20 which is an internal space of the container 1 of lower pressure Pl. Therefore, the pressure is reduced from Pd to Pl while keeping the volume Vd as it is. In the drawing, it corresponds to CD. The working fluid is discharged until the volume of the working chamber 12 becomes zero from Vd in the state of the pressure Pl. In the drawings, it corresponds to DE.

On the PV diagram, since the area indicates the workload, power that can be collected by the expander 18 corresponds to an area surrounded by ABCDE on the PV diagram.

On the other hand, if the volume ratio (Vd/Vs) of the expander 18 is set such that it satisfies the complete expansion (Pd=Pl), power that can be collected by the expander 18 corresponds to an area surrounded by ABCFDE on the PV diagram. Therefore, in the case of the incomplete expansion, the power that can be collected is reduced by the portion of the area surrounded by CFD as compared with the complete expansion. That is, incomplete expansion loss corresponding to the area CFD is generated.

Excessive expansion shown in FIG. 20(b) will be explained.

The intake stroke and the expansion stroke are the same as those of the incomplete expansion of FIG. 20(a). On the PV diagram, the intake stroke is indicated with AB, and the expansion stroke is indicated with BC. During the discharge stroke, the working chamber 12 of the pressure Pd comes into communication with the discharge hole 2b, and the working fluid flows in from the discharge space 20 of the higher pressure Pl. Therefore, the pressure rises from Pd to Pl while keeping the volume of the working chamber 12 as it is. In the drawing, it corresponds to CD. In the state of the pressure Pl, it is discharged until the volume of the working chamber 12 becomes zero from Vd. In the drawing, it corresponds to DE.

The power that can be collected by the expander 18 corresponds to a value obtained by subtracting an area surrounded by CDEG corresponding to the discharge workload required because the pressure rises from PD to Pl during the discharge stroke from an area surrounded by ABCG collected during the expansion stroke. That is, the power that can be collected by the expander 18 corresponds to a value obtained by subtracting the area surrounded by CDF from the area surrounded by ABFE.

On the other hand, if the volume ratio (Vd/Vs) of the expander 18 is set such that the volume ratio (Vd/Vs) satisfies the complete expansion (Pd=Pl), the power that can be collected by the expander 18 corresponds to an area surrounded by ABFE on the PV diagram. Thus, in the case of the excessive expansion, the power that can be collected is reduced by an area surrounded by CDF as compared in the case of the complete expansion. That is, incompletion expansion loss corresponding to the area CDF is generated.

As described above, in the conventional expander, since the volume ratio (Vd/Vs) is constant, the incomplete expansion loss or excessive expansion loss is generated, and in the case of the complete expansion, there is a problem that only power smaller than power that can be obtained from the working fluid is obtained.

The present invention has been accomplished to solve the above conventional problem, and it is an object of the invention to provide an efficient expander that can prevent the incomplete expansion loss or excessive expansion loss.

### DISCLOSURE OF THE INVENTION

A first aspect of the present invention provides an expander comprising a cylinder, a shaft having an eccentric portion, a roller which is fitted to the eccentric portion and which eccentrically rotates inside the cylinder, a closing member for closing both end surfaces of the cylinder, a vane for partitioning a space formed by the cylinder, the roller and the closing member into a plurality of working chambers, a suction hole through which working fluid flows into the working chamber, a discharge hole through which the working fluid is discharged from the working chamber into a discharge space, and flow-in timing control means which controls the flow of the working fluid into the suction hole, in which the expander expands the working fluid, wherein the expander which expands the working fluid further comprises pressure ratio control means which varies a ratio between pressure when expansion stroke of the working chamber is started and pressure when the expansion stroke is completed.

With this aspect, even if the pressure in the discharge space is varied, the pressure in the working chamber and the pressure in the discharge space when the expansion stroke is completed can match with each other, and excessive expansion loss of the expander can be prevented. Thus, an efficient expander can be provided.

According to a second aspect of the invention, in the expander of the first aspect, a differential pressure regulating valve which is operated by a difference between pressure in the working chamber and pressure in the discharge space is used as the pressure ratio control means.

With this aspect, the opening and closing operation of the valve can automatically controlled by detecting the excessive expansion by means of the difference between the pressure in the working chamber and the pressure in the discharge space and thus, the excessive expansion loss can be prevented from being generated reliably with a simple structure.

According to a third aspect of the invention, in the expander of the second aspect, the differential pressure regulating valve is provided in the discharge hole.

With this aspect, the excessive expansion loss can be prevented from being generated with such an extremely simple structure that the differential pressure regulating valve is only added to the discharge hole of a conventional expander.

According to a fourth aspect of the invention, in the expander of the third aspect, the differential pressure regulating valve is closed when the pressure in the working chamber is lower than the pressure in the discharge space.

With this aspect, when the excessive expansion is generated in the expansion stroke, if the differential pressure regulating valve is closed to tightly close the working chamber, the working fluid in the working chamber is repressed, the excessive expansion loss can be prevented from being generated.

According to a fifth aspect of the invention, in the expander of the fourth aspect, the differential pressure regulating valve is a reed valve.

With this aspect, the differential pressure regulating valve is closed when the excessive expansion is generated. It is possible to constitute the differential pressure regulating valve extremely easily.

According to a sixth aspect of the invention, in the expander of the fourth aspect, the differential pressure regulating valve has a circular conical valve portion.

With this aspect, since the wasted volume caused by the discharge hole becomes small, deterioration in efficiency can be prevented.

According to a seventh aspect of the invention, in the expander of the second aspect, the pressure ratio control means comprises a communication hole which brings the working chamber and the discharge space into communication with each other, and a differential pressure regulating valve provided in the communication hole.

With this aspect, it is possible to prevent the excessive expansion loss from being generated with an extremely simple structure.

According to an eighth aspect of the invention, in the expander of the seventh aspect, the differential pressure regulating valve is opened when the pressure in the working chamber is lower than the pressure in the discharge space.

With this aspect, if the pressure in the working chamber becomes lower than the pressure in the discharge space even slightly, the working fluid flows into the working chamber from the discharge space, and the excessive expansion can be prevented.

According to a ninth aspect of the invention, in the expander of the eighth aspect, an opening of the communication hole at the working chamber is formed in the closing member.

With this aspect, seal portions of the roller and the cylinder are not superposed on each other, the leakage of working fluid is reduced and deterioration in efficiency can be prevented.

According to a tenth aspect of the invention, in the expander of the second aspect, the pressure ratio control means comprises a first differential pressure regulating valve provided in the discharge hole, and a second differential pressure regulating valve provided in the communication hole which brings the working chamber and the discharge space into communication with each other.

With this aspect, in the expansion stroke, the pressure in the working chamber becomes slightly lower than the pressure in the discharge space due to pressure loss of the working fluid flowing through the second differential pressure regulating valve. Thus, even if excessive expansion loss is generated, repressing is carried out by the first differential pressure regulating valve, and excessive expansion loss can be reduced.

According to an eleventh aspect of the invention, in the expander of any one of the first to tenth aspects, fluid which expands from liquid phase or supercritical phase to gas-liquid two-phase is used as the working fluid.

When fluid expands from liquid phase or supercritical phase to gas-liquid two-phase, a specific volume of the working fluid is largely varied depending upon a ratio of gas and liquid and excessive expansion or incomplete expansion is prone to be generated. According to this aspect, even when the excessive expansion or incomplete expansion is prone to be generated, it is possible to suppress the excessive expansion loss, and the efficiency of the expander can be enhanced.

According to a twelfth aspect of the invention, in the expander of any one of the first to eleventh aspects, the expander is utilized in a heat pump cycle which uses carbon dioxide as the working fluid.

The carbon dioxide is environmentally friendly but a difference between high pressure and low pressure of the heat pump cycle is great, and even when the pressure ratio is slightly varied, a large excessive expansion loss is generated. With this aspect, the efficiency of a high pressure using the carbon dioxide can be enhanced.

According to a thirteenth aspect of the invention, in the expander of the twelfth aspect, a shaft of the expander is directly connected to a shaft of a compressor used in the heat pump cycle.

With this aspect, excessive expansion when the expander is started can be prevented, no torque variation is generated. Therefore, the compressor of the heat pump cycle can efficiently and smoothly be started.

### BRIEF DESCRIPTION OF THE DRAWINGS

FIG. 1 is a vertical sectional view of an expander of a first embodiment of the present invention;

FIG. 2 is a transverse sectional view of the expander of the first embodiment of the invention;

FIG. 3 is a PV diagram of a working chamber of the expander of the first embodiment of the invention;

FIG. 4 is a transverse sectional view of an expander of a second embodiment of the invention;

FIG. 5 is a vertical sectional view of the expander of the second embodiment of the invention;

FIG. 6 is a vertical sectional view of an expander of a third embodiment of the invention;

FIG. 7 is a transverse sectional view of an expander of a fourth embodiment of the invention;

FIGS. 8 show operation of a working chamber of the expander of the fourth embodiment of the invention;

FIG. 9 is a PV diagram of the working chamber of the expander of the fourth embodiment of the invention;

FIG. 10 is a transverse sectional view of an expander of a fifth embodiment of the invention;

FIG. 11 is a vertical sectional view of the expander of the fifth embodiment of the invention;

FIG. 12 is a transverse sectional view of an expander of a sixth embodiment of the invention;

FIG. 13 is a transverse sectional view of an expander of a seventh embodiment of the invention;

FIG. 14 is a vertical sectional view of the expander of the seventh embodiment of the invention;

FIG. 15 is a PV diagram of a working chamber of an expander of the seventh embodiment of the invention;

FIG. 16 is a vertical sectional view of a conventional expander;

FIG. 17 is a transverse sectional view of the conventional expander;

FIGS. 18 show operation of a working chamber of the conventional expander;

FIGS. 19 show a conception of a conventional heat pump cycle; and

FIGS. 20 are PV diagrams of the conventional expander.

### BEST MODE FOR CARRYING OUT THE INVENTION

### FIRST EMBODIMENT

Embodiments of the present invention will be explained with reference to the drawings.

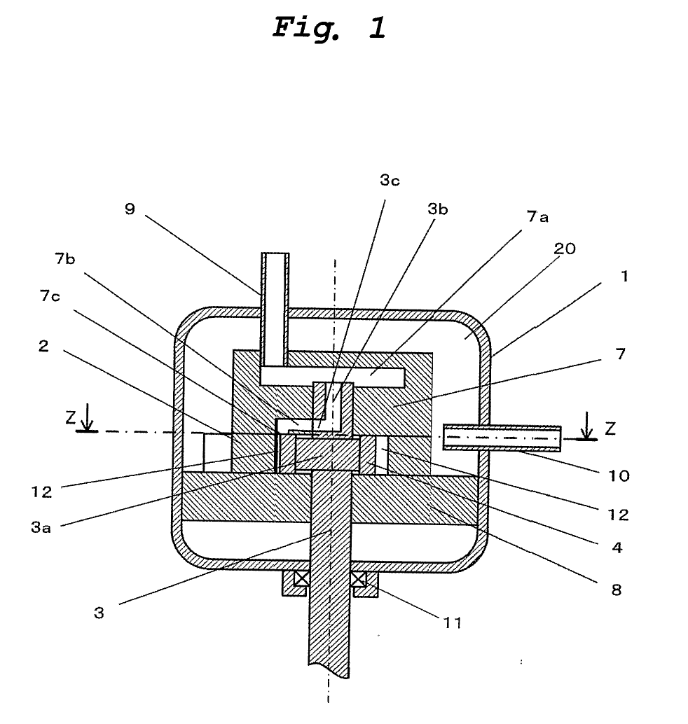

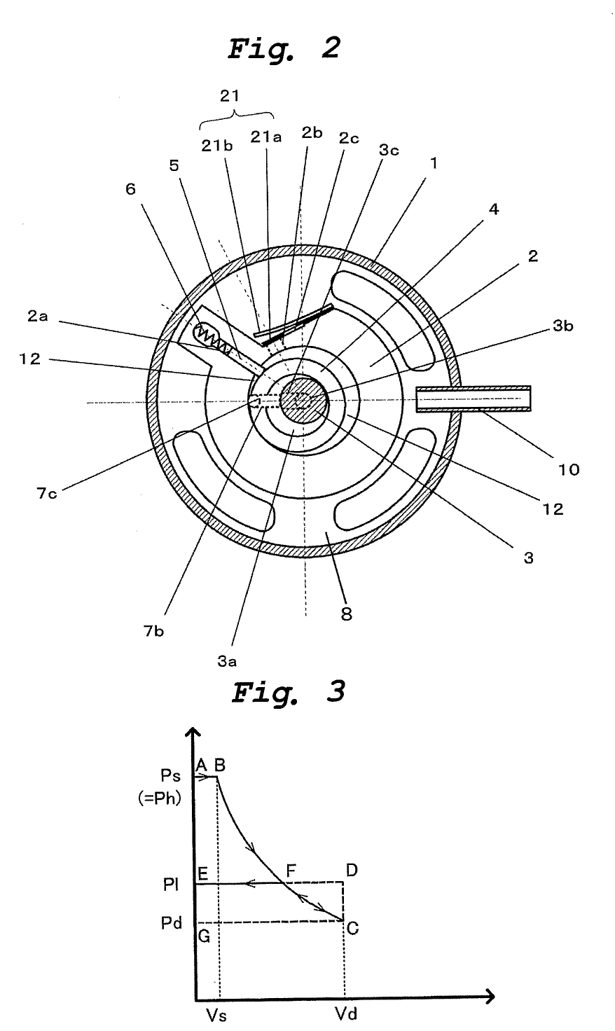

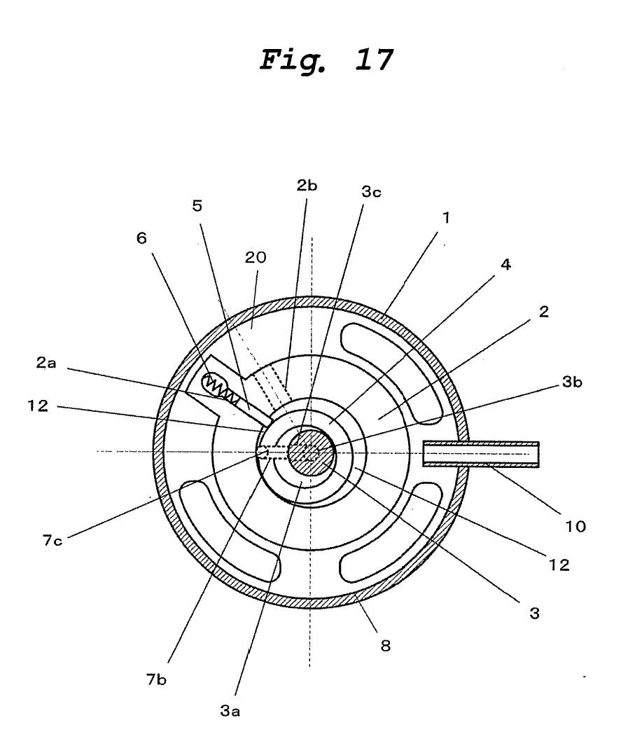

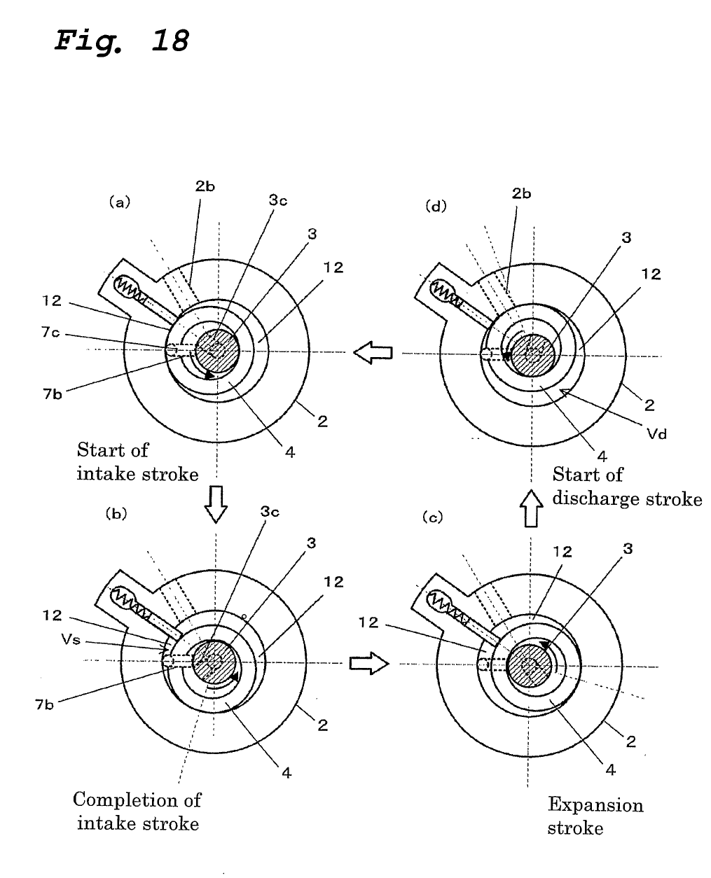

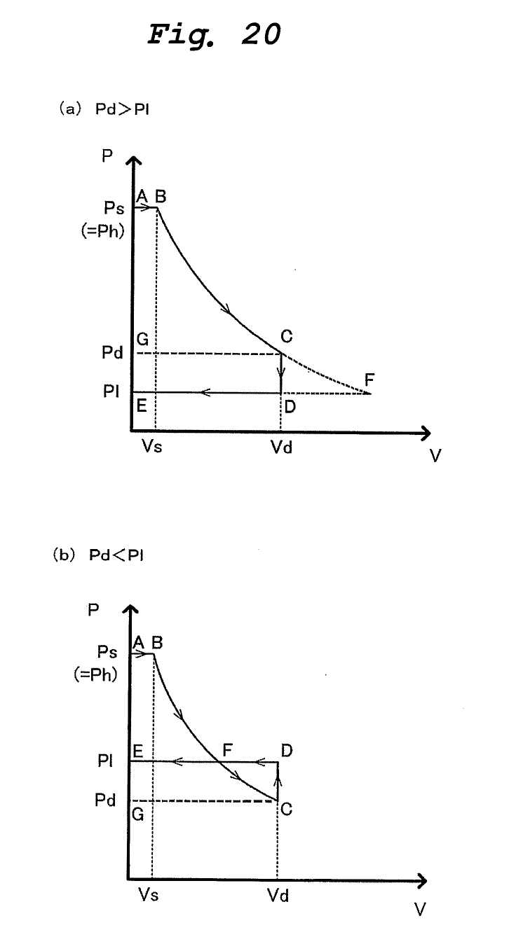

An expander in a first embodiment of the present invention has substantially the same structure as that of the conventional expander explained with reference to FIGS. 16 to 20 except that the discharge hole is provided with a differential pressure regulating valve. The same functional parts are designated with the same symbols, and explanation of the same structure and operation as those of the conventional example will be omitted. FIG. 1 is a vertical sectional view of the expander of the first embodiment. FIG. 2 is a transverse sectional view of the expander of the first embodiment. FIG. 1 corresponds to FIG. 16 showing the conventional expander, and FIG. 2 is the sectional view taken along the line Z-Z in FIG. 1.

The expander of this embodiment comprises a container 1, a cylinder 2 having a cylindrical inner wall, a shaft 3 having an eccentric portion 3a, a roller 4 which is fitted in the eccentric portion 3a of the shaft 3 and which eccentrically rotates in the cylinder 2, a vane 5 which reciprocates in a vane groove 2a of the cylinder 2 in a state in which a tip end of the vane 5 is in contact with an outer peripheral surface of the roller 4, a vane spring 6 for biasing the vane 5 against the roller 4, an upper bearing member 7 which closes an upper side end surface of the cylinder 2 and which supports the shaft 3, a lower bearing member 8 which closes a lower side end surface of the cylinder 2, which supports the shaft 3, and which is fixed the container 1 a suction pipe 9 for sucking working fluid from outside of the container 1, a discharge pipe 10 for discharging working fluid outside from the container 1, and a mechanical seal 11 through which the shaft 3 passes through the container 1.

A space formed by the cylinder 2, the roller 4, the upper bearing member 7 and the lower bearing member 8 as closing members is partitioned as a plurality of working chambers 12 by means of vanes 5. The upper bearing member 7 includes a suction space 7a, a suction passage 7b, and a suction hole 7c which serves as an opening on the side of the working chamber 12 of the suction passage 7b. The shaft 3 includes an axial passage 3b and a radial passage 3c. The cylinder 2 is provided with a discharge hole 2b through which working fluid is discharged from the working chamber 12 into the discharge space 20.

The radial passage 3c of the shaft 3 opens only a certain angle range of an outer peripheral surface of the shaft 3 as shown in FIG. 2, and the radial passage 3c and the suction passage 7b together form flow-in timing control means which is brought into communication and non-communication between the radial passage 3c and the suction passage 7b of the upper bearing member 7 repeatedly as the shaft 3 rotates, and controls the working fluid flowing into the radial passage 3c from the suction pipe 9 through the suction space 7a and the axial passage 3b. The communication and non-communication timing can be adjusted by shapes of the radial passage 3c and an opening of the suction passage 7b on the side of the shaft 3.

When the radial passage 3c and the suction passage 7b are brought into communication with each other, i.e., when the flow-in timing control means is opened, the working fluid is sucked into the working chamber 12 from the radial passage 3c through the suction passage 7b and the suction hole 7c.

In the expander of this embodiment, as shown in FIG. 2, the cylinder 2 is provided at its outer periphery with a notch 2c including the discharge hole 2b, and with a differential pressure regulating valve 21 comprising a valve stopper 21b and a reed valve 21a covering the discharge hole 2b. The notch 2c has effect that a space in which the differential pressure regulating valve 21 is disposed is secured, the cylinder 2 is thinned, and a space between the working chamber 12 and the differential pressure regulating valve 21 which is a wasted volume is shortened.

The differential pressure regulating valve 21 is designed such that it is closed when the pressure in the working chamber 12 is lower than the pressure in the discharge space 20, and it is opened when the pressure in the working chamber 12 is higher than the pressure in the discharge space 20. That is, the expander includes the differential pressure regulating valve 21 as pressure ratio control means which varies the ratio between pressure when the expansion stroke of the working chamber 12 is started and pressure when the expansion stroke is completed. In other words, even if the pressure in the discharge space 20 is varied, the pressure ratio control means can always equalize the pressure in the working chamber 12 and the pressure in the discharge space 20 when the expansion stroke is completed.

According to the expander of this embodiment, the volume ratio (Vd/Vs) which is a ratio of the suction volume Vs and the discharge volume Vd of the working chamber 12 is set sufficiently great so that incomplete expansion is not generated under any conditions.

For example, when the expander is used in a system in which in single phase region in gas phase or supercritical phase, high pressure is Ph and low pressure is Pl, if an assumed maximum pressure ratio is defined as (Ph/Pl) max, and an adiabatic exponent is defined as κ, a volume ratio (Vd/Vs) is set such as to satisfy the following equation.

$$\frac{Vd}{Vs} > {\{ {( \frac{Ph}{Pl} )}_{max} \}}^{\frac{1}{κ}} \qquad ( Equation 2 )$$

When the working fluid is expanded from the single phase region to two-phase region, if a specific volume ratio before the working fluid is expanded is defined as νh, a specific volume ratio in two-phase region after expansion of the working fluid is defined as νl and a ratio of an assumed maximum specific volume ratio is defined as (νl/νh)max, the volume ratio (Vd/Vs) is set such as to satisfy the following equation.

$$\frac{Vd}{Vs} > {( \frac{vl}{vh} )}_{max} \qquad ( Equation 3 )$$

The operation and effect of the expander of this embodiment having the above structure will be explained.

FIG. 3 is a PV diagram of the working chamber of the expander of the first embodiment.

If the shaft 3 rotates in the counterclockwise direction, the radial passage 3c of the shaft 3 and the suction passage 7b of the upper bearing member 7 are brought into communication with each other. With this the flow-in timing control means is opened, the intake stroke in which the high pressure working fluid flows into the working chamber 12 is started, and if the communication is cut off, the flow-in timing control means is closed, and the intake stroke is completed. The intake stroke corresponds to AB on the PV diagram, and the volume of the working chamber 12 at that time becomes equal to Vs, and the pressure becomes equal to Ps.

Then, the high pressure working fluid sucked into the working chamber 12 enters the expansion stroke where the working fluid is expanded and decompressed while rotating the shaft 3 in the direction increasing the volume of the working chamber 12. The expansion stroke corresponds to BC on the PV diagram, the volume of the working chamber 12 at that time becomes equal to Vd, and the pressure in the working chamber 12 becomes equal to Pd.

In this embodiment, excessive expansion is surely generated in the expansion stroke BC, and the pressure Pd at a C point at which the expansion stroke is completed becomes lower than the pressure Pl in the container 1 which is the discharge space 20.

At that time, in this embodiment, the discharge hole 2b is provided with the differential pressure regulating valve 21, and the pressure Pd in the working chamber 12 is lower than the pressure Pl in the discharge space 20. Therefore, the differential pressure regulating valve 21 is closed. Thus, the differential pressure regulating valve 21 is closed to tightly close the working chamber 12 and thus, the working fluid does not flow into the working chamber 12.

As the shaft 3 rotates, the volume in the working chamber 12 is reduced, and the working fluid is compressed along CF on the PV diagram.

If the pressure in the working chamber 12 rises to a value equal to the pressure in the discharge space 20, the differential pressure regulating valve 21 is opened, and the discharge stroke is started. The discharge stroke corresponds to FE on the PV diagram.

As apparent from the above operation and explanation of the PV diagram, power that can be collected by the expander of this embodiment corresponds to an area surrounded by ABFE on the PV diagram, and the excessive expansion corresponding to an area surrounded by FCD is not generated. Therefore, in the expander of this embodiment, when the pressure in the working chamber 12 is lower than the pressure in the discharge space 20, the differential pressure regulating valve 21 is closed. With this, the excessive expansion loss is prevented, and the efficiency of the expander can be enhanced. Since the volume ratio of the expander is previously set so that incomplete expansion is not generated so as to cope with any variation in the pressure Pl of the discharge space 20, incomplete expansion loss and excessive expansion loss are prevented and high efficiency can always be maintained.

As the pressure ratio control means of this embodiment, the expander uses a differential pressure regulating valve which is automatically opened and closed with a difference between the pressure in the working chamber and the pressure in the discharge space. Therefore, it is possible to reliably prevent the excessive expansion loss with a simple structure. The differential pressure regulating valve of this embodiment can be realized with an extremely simple structure in which the discharge hole which is also owned by the conventional example is provided with the valve. Further, the valve is the reed valve, there is effect that a valve structure that can be closed when the excessive expansion is generated can be formed in an extremely simple manner.

### SECOND EMBODIMENT

An expander of a second embodiment of this invention is the same as that of the first embodiment except that positions of the discharge hole and the differential pressure regulating valve are changed. The same functional parts are designated with the same symbols, and explanation of the same structure and effect will be omitted.

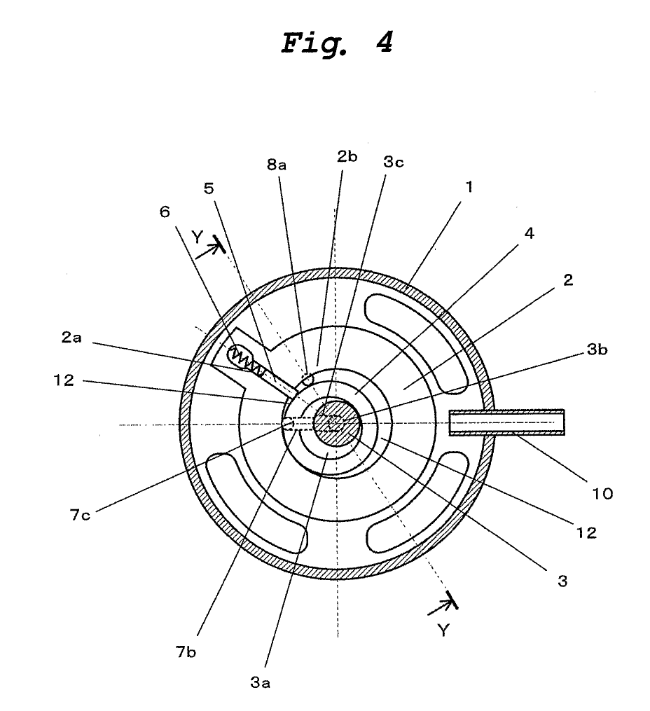

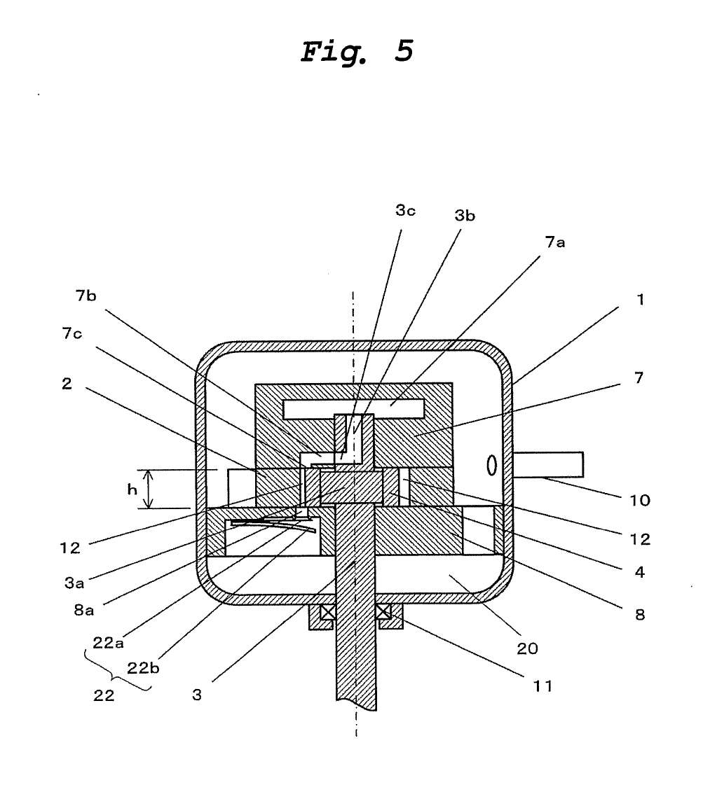

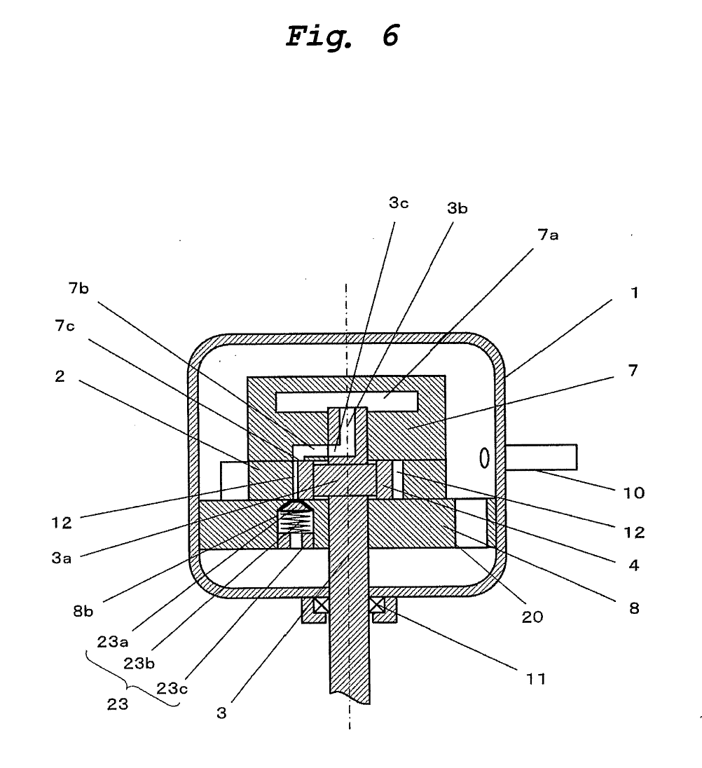

FIG. 4 is a transverse sectional view of the expander of the second embodiment. FIG. 5 is a vertical sectional view of the expander of the second embodiment taken along the line Y-Y in FIG. 4.

In the expander of this embodiment, a lower bearing member 8 as a closing member for closing the lower end surface of the cylinder 2 is provided with a discharge hole 8a through which working fluid is discharged from the working chamber 12 into the discharge space 20, and the discharge hole 8a is provided with a differential pressure regulating valve 22. The differential pressure regulating valve 22 comprises a reed valve 22a and a valve stopper 22b.

In the second embodiment, positions of the discharge hole 8a and the differential pressure regulating valve 22 are changed as compared with the first embodiment, but the same effect as that of the first embodiment can be obtained of course. In addition, the following effect can be obtained.

That is, when the discharge hole 2b is formed in a wall surface of the cylinder 2 as in the first embodiment since the notch 2c is formed, the strength of the cylinder 2 is reduced and the cylinder 2 is deformed, a gap between the roller 4 and the cylinder 2 is enlarged, the working fluid leaks and performance of the expander is deteriorated.

Whereas, according to the expander of the second embodiment, the discharge hole 8a can be provided with the differential pressure regulating valve 22 without deteriorating the strength of the cylinder 2, and the performance deterioration that may be generated when the cylinder 2 is deformed and the working fluid is leaked can be prevented.

When the discharge hole 2b is formed in the wall surface of the cylinder 2 as in the first embodiment, since the notch 2c is formed, the thickness of the vane groove 2a on the side of the discharge hole 2b is reduced and the vane groove 2a becomes prone to be deformed. Therefore, working fluid is leaked from the gap between the vane groove 2a and the vane 5, and the performance of the expander is deteriorated. Further, there is an adverse possibility that the deformation of the vane groove 2a increases the sliding surface pressure between the vane groove 2a and the vane 5, abnormal wear is prone to be generated and the reliability of the expander is deteriorated.

Whereas, in this second embodiment, the discharge hole 8a can be provided with the differential pressure regulating valve 22 without deteriorating the strength of the vane groove 2a of the cylinder 2, and the performance and reliability can be enhanced.

When the expander is used in a heat pump cycle which uses carbon dioxide having smaller specific volume than flon as the working fluid, or when the revolution number of the expander is desired to be set higher with the same flow rate of the working fluid, it is necessary to reduce the volume of the working chamber 12. In this case, the height h of the cylinder 2 is set smaller. However, when the discharge hole 2b is formed in the wall surface of the cylinder 2 and the differential pressure regulating valve 21 is provided in the discharge hole 2b as in the first embodiment, since the space is narrow, it may be difficult to dispose the differential pressure regulating valve 21 itself, or the shape of the differential pressure regulating valve 21 is limited and the valve 21 can not be designed into a desired shape in some cases. Thus, the strength of the differential pressure regulating valve 21 becomes insufficient, and the differential pressure regulating valve 21 may be damaged in some cases.

Whereas, according to the expander of the second embodiment, since the lower bearing member 8 as the closing member is provided with the discharge hole 8a and the differential pressure regulating valve 22, it is possible to secure sufficient space to provide the differential pressure regulating valve 22, and the differential pressure regulating valve 22 can be formed into a desired shape.

### THIRD EMBODIMENT

An expander of a third embodiment of this invention is the same as that of the second embodiment except that shapes of the discharge hole and the differential pressure regulating valve are changed. The same functional parts are designated with the same symbols, and explanation of the same structure and effect will be omitted.

FIG. 6 is a vertical sectional view of the expander of the third embodiment of the invention.

According to the expander of the third embodiment, the lower bearing member 8 is provided with a discharge hole 8b whose portion closer to the working chamber 12 is formed into a circular conical surface. The expander is provided with a differential pressure regulating valve 23 for opening and closing the discharge hole 8b. The differential pressure regulating valve 23 comprises a valve portion 23a having such a circular conical surface that is fitted into the discharge hole 8b, a valve spring 23b for biasing the valve portion 23a against the discharge hole 8b, and a valve spring pedestal 23c for fixing the valve spring 23b.

According to the differential pressure regulating valve 23, when the pressure in the working chamber 12 is lower than that in the discharge space 20, the spring force of the valve spring 23b overcomes a force caused by a difference between the pressure in the discharge space 20 and the pressure in the working chamber 12, and the discharge hole 8b is closed. When the pressure in the working chamber 12 is higher than that in the discharge space 20, the force caused by a difference between the pressure in the discharge space 20 and the pressure in the working chamber 12 overcomes the spring force of the valve spring 23b, and the discharge hole 8b is opened.

Although the shapes of the discharge hole 8b and the differential pressure regulating valve 23 are changed in this embodiment, since the discharge hole 8b and the differential pressure regulating valve 23 are disposed at the same positions as in the second embodiment, the same effect as that of the second embodiment can be obtained of course. In addition, the following effect can be obtained.

That is, according to the expander of this embodiment, a portion of the discharge hole 8b closer to the working chamber 12 and the valve portion 23a of the differential pressure regulating valve 23 comprise the circular conical surfaces and they are fitted to each other. Therefore, when the differential pressure regulating valve 23 is closed, a wasted volume of a space between the working chamber 12 and the differential pressure regulating valve 23 becomes extremely small.

Therefore, if the wasted volume having pressure as low as the discharge space 20 is brought into communication with the high pressure working chamber 12, the pressure in the working chamber 12 is reduced, and the power that can be collected by the working chamber 12 is reduced. Therefore, it is possible to prevent the efficiency of the expander from being deteriorated.

In the first to third embodiments, the differential pressure regulating valves 21 and 22 using the reed valves 21a and 22a, and the differential pressure regulating valve 23 using the valve portion 23a and the valve spring 23b are described. Alternatively, a differential pressure regulating valve which is opened when the pressure in the working chamber 12 is higher than the pressure in the discharge space 20 may be used. With this differential pressure regulating valve also, the same effect can be obtained irrespective of its structure of course.

### FOURTH EMBODIMENT

An expander of a fourth embodiment of this invention is the same as that of the conventional expander explained with reference to FIGS. 16 to 20 except that the cylinder has a communication hole for connecting the working chamber and the discharge space to each other and a differential pressure regulating valve is provided in the communication hole. The same functional parts are designated with the same symbols, and explanation of the same structure and effect will be omitted.

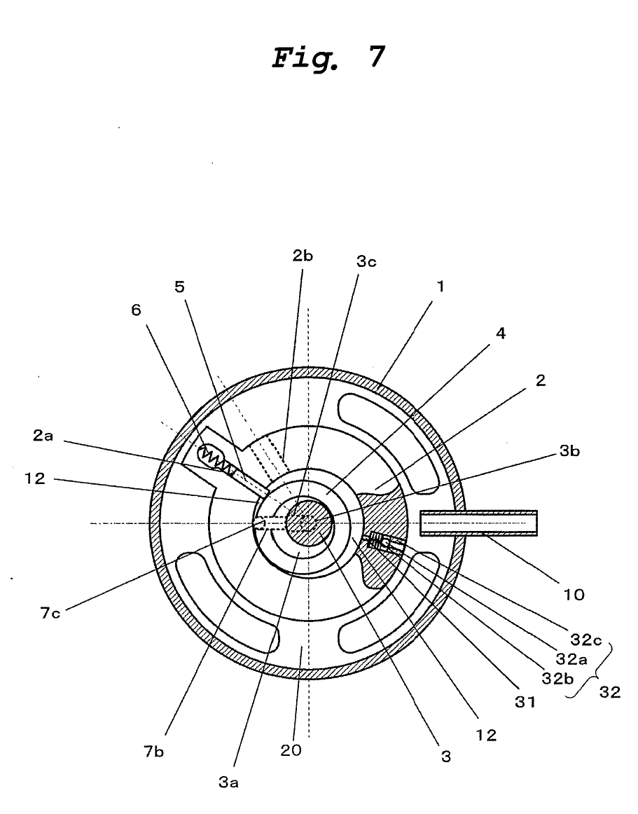

FIG. 7 is a transverse sectional view of the expander of the fourth embodiment. A vertical sectional view thereof is the same as that of the conventional expander shown in FIG. 16, and FIG. 7 is taken along the line Z-Z in FIG. 16. Only a portion of the expander near a communication hole 31 is shown in cross section.

In addition to the conventional structure shown in FIG. 16, the expander of this embodiment comprises the communication hole 31 which connects the discharge space 20 and the working chamber 12 with each other provided in the cylinder 2, and a differential pressure regulating valve 32 provided in the communication hole 31. Although the communication hole 31 is provided in a region through an angle of 210° in the counterclockwise direction from the position of the vane groove 2a as viewed from the center axis of the shaft 3, but the position of the communication hole 31 is not limited to this. The conditions of the position of the communication hole 31 will be described later.

The differential pressure regulating valve 32 comprises a valve portion 32a, a valve spring 32b and a valve spring pedestal 32c. Contrary to the differential pressure regulating valves 21 to 23 of the first to third embodiments, the differential pressure regulating valve 32 is closed when the pressure in the working chamber 12 is higher than that in the discharge space 20 and the differential pressure regulating valve 32 is opened when the pressure in the working chamber 12 is lower than that in the discharge space 20. That is, the differential pressure regulating valve 32 functions as the pressure ratio control means which varies the ratio of the pressure when the expansion stroke of the working chamber 12 is started and the pressure when the expansion stroke is completed.

According to the expander of this embodiment, the volume ratio (Vd/Vs) which is a ratio of the suction volume Vs and the discharge volume Vd is set sufficiently great so that incomplete expansion is not generated under any conditions. The setting manner is as described in the first embodiment.

The operation and effect of the expander of this embodiment having the above structure will be explained.

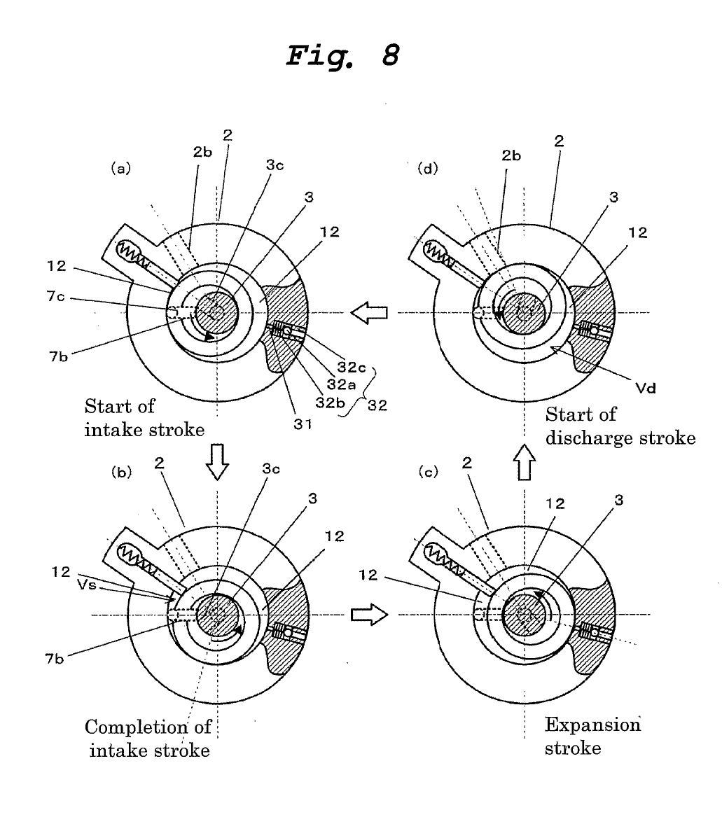

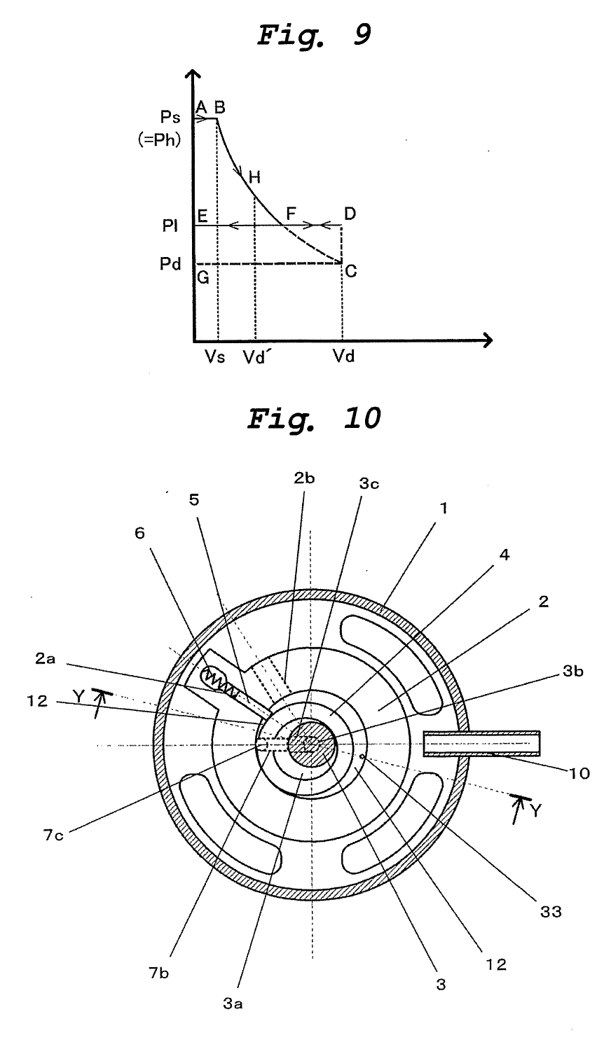

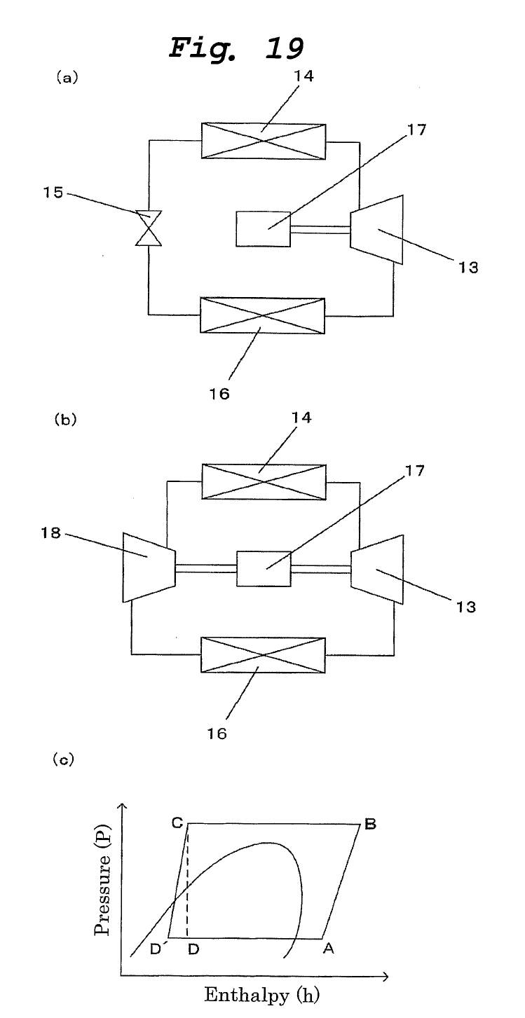

FIGS. 8 show operation of the expander of the fourth embodiment, and correspond to FIGS. 18. Only a portion of the expander near the communication hole 31 is shown in cross section. The axial passage 3b and the radial passage 3c of the shaft 3, as well as the suction passage 7b and the suction hole 7c of the upper bearing member 7 are shown with broken lines in the drawings. FIG. 9 is a PV diagram of the working chamber 12 of the expander of the fourth embodiment.

The operation of the expander will be explained in comparison with the PV diagram based on the working chamber 12. The following explanation does not depend on the structure of the flow-in timing control means.

FIG. 8(a) shows a state immediately before the flow-in timing control means is opened, i.e., a state before the intake stroke, and this corresponds to a point A on the PV diagram in FIG. 9. If the shaft 3 rotates in the counterclockwise direction from this state, the radial passage 3c of the shaft 3 and the suction passage 7b of the upper bearing member 7 are brought into communication with each other, the flow-in timing control means is opened, and the intake stroke in which the high pressure working fluid flows into the working chamber 12 is started.

A state shown in FIG. 8(b) after the shaft 3 rotated in the counterclockwise direction shows an instant when the flow-in timing control means is closed, i.e., a state of completion of the intake stroke, and this corresponds to a point B in FIG. 9. The volume of the working chamber 12 becomes equal to the suction volume Vs of the expander.

Then, the high pressure working fluid sucked into the working chamber 12 enters the expansion stroke where the working fluid is expanded and decompressed while rotating the shaft 3 in a direction increasing the volume of the working chamber 12. In the state shown in FIG. 8(c), the working chamber 12 is brought into communication with the communication hole 31.

The communication hole 31 is provided at a position where excessive expansion is not generated under any condition other than at a period of transition in the working chamber 12 at an instant when the working chamber 12 and the communication hole 31 are brought into communication with each other, i.e., in a state shown in FIG. 8(c).

For example, assuming that the expander is used in a system in which the state shown in FIG. 8(c) is on a point H on the PV diagram in FIG. 9, volume at that time is defined as Vd′, and in single phase region in gas phase or supercritical phase, high pressure is Ph, and low pressure is Pl. In this system, if an assumed minimum pressure ration is defined as (Ph/Pl)min, and adiabatic exponent is defined as κ, the volume ratio (Vd′/Vs) is set such as to satisfy the following equation.

$$\frac{{Vd}^{′}}{Vs} < {\{ {( \frac{Ph}{Pl} )}_{min} \}}^{\frac{1}{κ}} \qquad ( Equation 4 )$$

When the working fluid is expanded from the single phase region to two-phase region, if a specific volume before the working fluid is expanded is defined as νh, an average specific volume of gas phase and liquid phase after the expansion of the working fluid is defined as νl, and a ratio of an assumed minimum specific volume is defined as (νl/νh)min, the volume ratio (Vd′/Vs) is set such as to satisfy the following equation.

$$\frac{{Vd}^{′}}{Vs} < {( \frac{vl}{vh} )}_{min} \qquad ( Equation 5 )$$

If the shaft 3 further rotates, the pressure in the working chamber 12 is further reduced from the state of the point H on the PV diagram shown in FIG. 9 and becomes equal to a point F in FIG. 9. Thereafter, the working fluid is excessively expanded in the conventional expander, but in this embodiment, the pressure in the working chamber 12 is lower than the pressure Pl of the discharge space 20 by the excessive expansion and at the same time, the differential pressure regulating valve 32 of the communication hole 31 is opened, working fluid of the pressure Pl flows from the discharge space 20 into the working chamber 12 and thus, the pressure in the working chamber 12 is not reduced lower than the pressure Pl of the discharge space 20. That is, excessive expansion is not generated.

If variation from FIG. 8(c) to FIG. 8(d) where the volume becomes equal to Vd which is a value immediately before discharge is applied to the PV diagram in FIG. 9, in the case of the conventional expander, since the excessive expansion is generated, the volume is varied along FC in FIG. 9 and the pressure becomes equal to Pd, and at an instant when the working chamber 12 is are brought into communication with the discharge hole 2b, the pressure rises to Pl along CD in FIG. 9.

Whereas, in this embodiment, in cooperation with the communication hole 31 and the differential pressure regulating valve 32, the volume is varied to Vd along Fd while maintaining the pressure Pl at constant. Then, the discharge stroke is started together with rotation of shaft 3, the working fluid is discharged into the discharge space 20 from the working chamber 12 through the discharge hole 2b, and this corresponds to DE in FIG. 9.

As apparent from the above operation and explanation of the PV diagram, power that can be collected by the expander of this embodiment corresponds to an area surrounded by ABFE on the PV diagram, and the excessive expansion corresponding to an area surrounded by FCD which was generated in the conventional expander is not generated. Therefore, the efficiency of the expander can be enhanced. Further, it is possible to cope with any variation in pressure Pl of the discharge space 20, and excessive expansion is prevented, and high efficiency can always be maintained.

In the expander of this embodiment, there is provided the communication hole 31 having the differential pressure regulating valve 32 at one location, but two or more communication holes may be provided at two or more locations, and if at least one of the communication holes is disposed at a location where the equation 4 or 5 is satisfied, the same effect as that obtained when the communication hole is provided at one location can be obtained of course.

If the communication hole 31 is provided at one location, the working fluid flowing from the communication hole 31 is not easily sent over the working chamber 12 instantaneously and pressure loss may be generated due to a crescent thin and long shape of the working chamber 12 or due to a passage resistance of the communication hole 31 and thus, excessive expansion loss can not be eliminated completely. However, if two or more communication holes 31 are provided at two or more locations, it is possible to distribute the working fluid over the entire space in the working chamber 12 swiftly and thus, the effect which the excessive expansion is prevented and efficiency of the expander can be enhanced is exhibited more remarkably.

### FIFTH EMBODIMENT

An expander of a fifth embodiment of this invention is the same as that of the fourth embodiment except that a position of the discharge hole is changed. The same functional parts are designated with the same symbols, and explanation of the same structure and effect will be omitted.

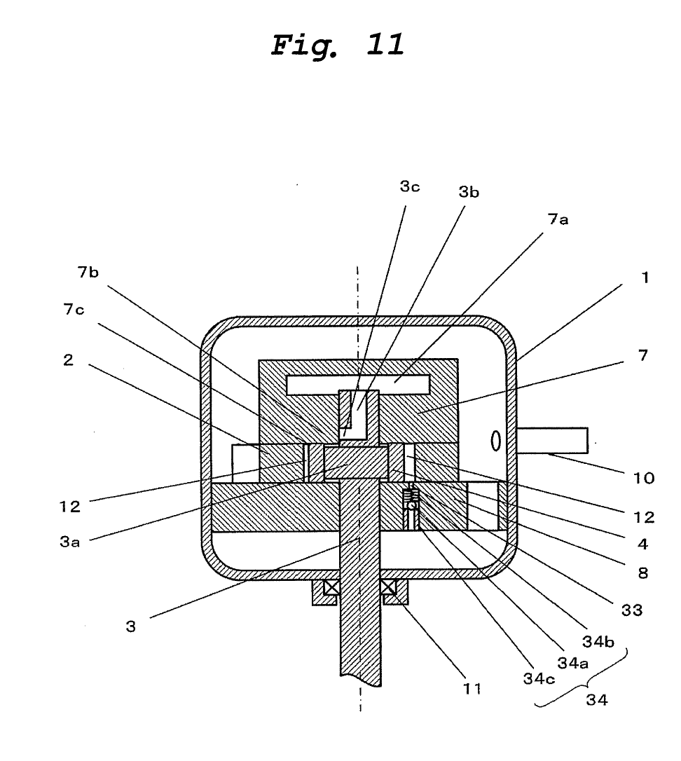

FIG. 10 is a transverse sectional view of the expander of the fifth embodiment. FIG. 11 is a vertical sectional view of the expander of the fifth embodiment taken along the line Y-Y in FIG. 10.

In the expander of this embodiment, the lower bearing member 8 is provided with a communication hole 33 which connects the working chamber 12 and the discharge space 20 with each other. That is, a hole opening at the working chamber 12 of the communication hole 33 is provided in the lower bearing member 8 as a closing member. The communication hole 33 is provided with a differential pressure regulating valve 34 comprising a valve portion 34a, a valve spring 34b and a valve spring pedestal 34c.

Although the position of the communication hole 33 is changed in this embodiment, the same effect as that of the fourth embodiment can be obtained of course. In addition, the following effect can be obtained.

That is, when the communication hole 31 is formed in the wall surface of the cylinder 2 as in the fourth embodiment, if seal portions which are line contact points of the roller 4 and the cylinder 2 are superposed on each other at the communication hole 31 as the shaft 3 rotates, working fluid leaks between the working chambers 12 partitioned by the seal portions due to the communication hole 31.

Whereas, in the expander of the embodiment, since the lower bearing member 8 as one of the closing members is provided with the communication hole 33, the seal portions of the roller 4 and the cylinder 2 are not superposed on each other and thus, the leakage of the working fluid can be reduced, and the efficiency can be enhanced. The upper bearing member 7 as the other closing member may be provided with a communication hole (not shown) and with this structure also, the same effect can be obtained.

### SIXTH EMBODIMENT

An expander of a sixth embodiment of this invention is the same as that of the fifth embodiment except that a position of the discharge hole is changed. The same functional parts are designated with the same symbols, and explanation of the same structure and effect will be omitted.

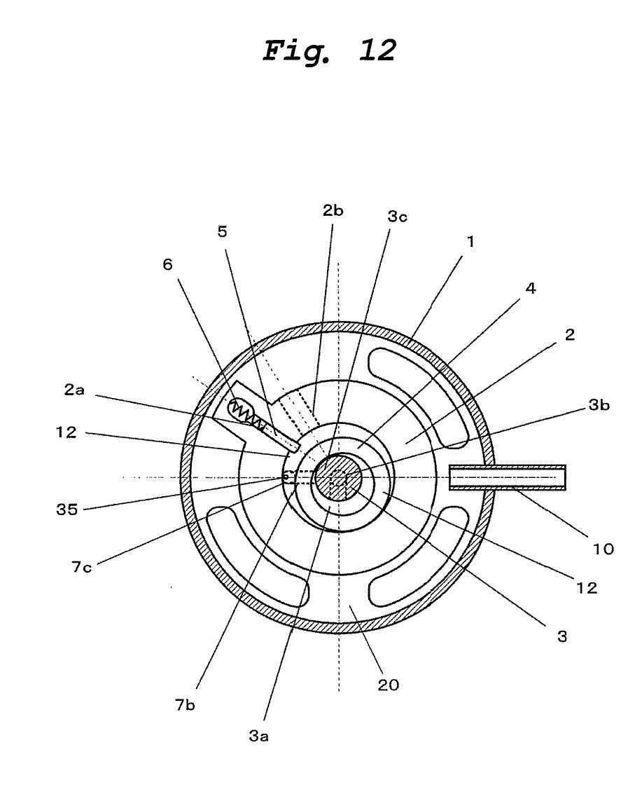

FIG. 12 is a transverse sectional view of the expander of the sixth embodiment.

According to the expander of this embodiment, the communication hole 35 is provided at the same angular position as the suction hole 7c as viewed from the center axis of the shaft 3.

Although the position of the communication hole 35 is changed in this embodiment, the same effect as that of the fifth embodiment can be obtained of course. In addition, the following effect can be obtained.

That is, when the conventional expander, or the expander of any of the first to fifth embodiments is used for a heat pump cycle as shown in FIG. 19(b), the pressure Ph of the gas cooler 14 and the pressure Pl of the evaporator 16 are equal to each other when the heat pump cycle is stopped, and a difference between Ph and Pl immediately after the cycle is started is extremely small. Therefore, during a period immediately after the cycle is started to a period when the driving state is shifted to a normal driving state, excessive expansion to a certain expansion ratio is generated.

Therefore, a load required for the excessive expansion when the cycle is started becomes great, the expander is not operated smoothly due to torque variation, and this is caught in a vicious circle of delaying the start of the heat pump cycle.

Especially in the case of a heat pump cycle of a type in which a shaft of the compressor 13 and a shaft of the expander 18 are directly connected to each other as shown in FIG. 19(b), the start of the compressor 13 is adversely affected by torque variation of a load caused by the excessive expansion of the expander 18. Especially in the case of a compressor 13 using a brushless motor 17 of sensor-less control by an inverter, loss of synchronism is prone to be generated due to deviation in rotation caused by torque variation when the cycle is started.

Whereas, in the case of the expander of this embodiment, since the communication hole 35 is provided at the same angular position as the suction hole 7c as viewed from the center axis of the shaft 3, the working chamber 12 and the communication hole 35 are brought into communication with each other when the intake stroke is completed and the stroke is shifted to the expansion stroke. Therefore, excessive expansion is not generated even when the cycle is started.

Therefore, torque variation is not generated by the excessive expansion, and the heat pump cycle can smoothly be started efficiently. This is effective especially for a heat pump cycle in which the shaft of the compressor 13 is directly connected to the shaft of the expander 18.

### SEVENTH EMBODIMENT

An expander of a seventh embodiment of this invention is the same as that of the second embodiment except that the cylinder is provided with a communication hole which brings the working chamber and the discharge space into communication with each other, and a differential pressure regulating valve is provided in the communication hole. The same functional parts are designated with the same symbols, and explanation of the same structure and effect will be omitted.

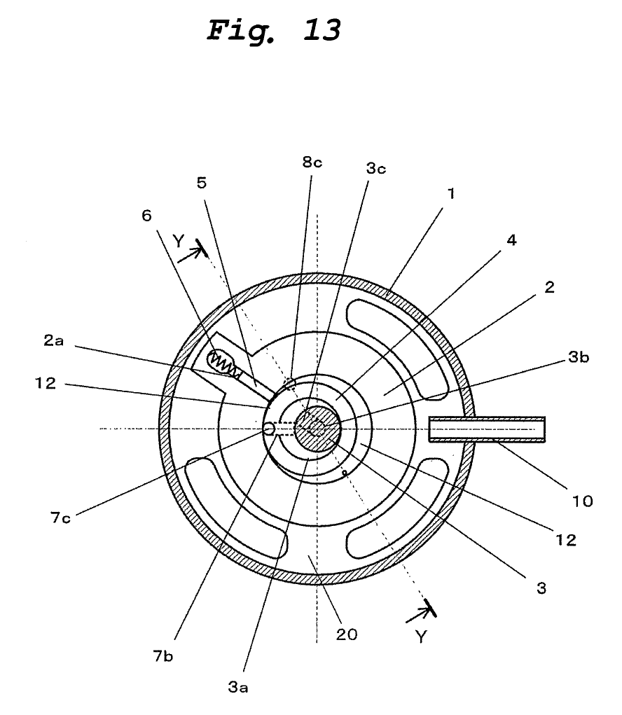

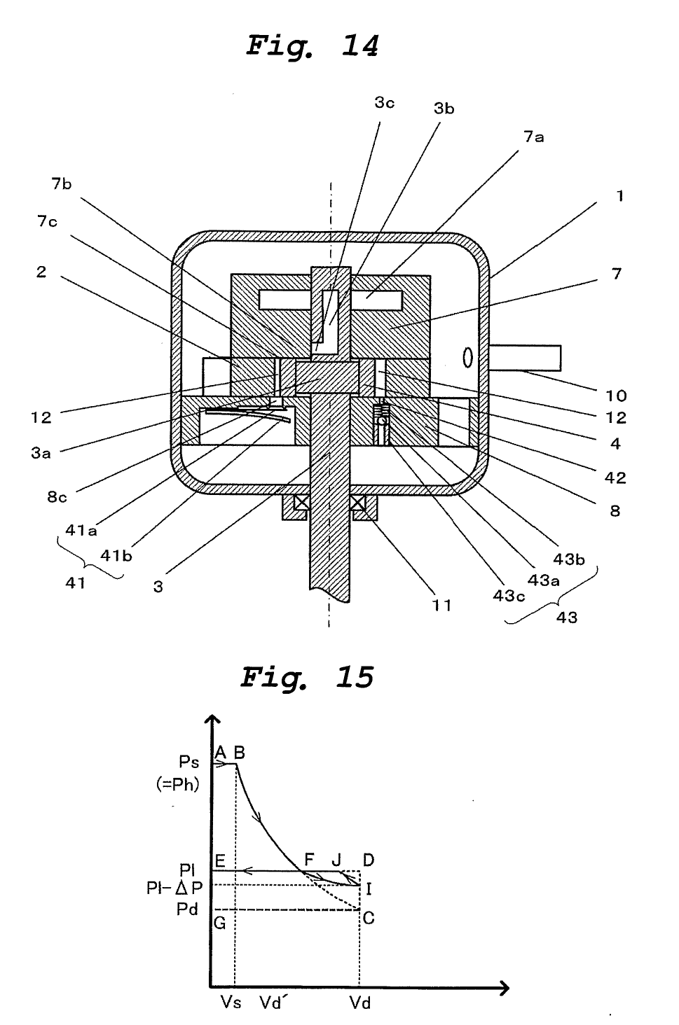

FIG. 13 is a transverse sectional view of the expander of the seventh embodiment. FIG. 14 is a vertical sectional view of the expander of the seventh embodiment taken along the line Y-Y in FIG. 13.

According to the expander of this embodiment, a first differential pressure regulating valve 41 comprising a reed valve 41a and a valve stopper 41b is provided in a discharge hole 8c, the cylinder 2 is provided with a communication hole 42 through which the working chamber 12 and the discharge space 20 are connected to each other, and a second differential pressure regulating valve 43 is provided in the communication hole 42. The second differential pressure regulating valve 43 comprises a valve portion 43a, a valve spring 43b and a valve spring pedestal 43c.

In the expander of this embodiment, since the structures of the discharge hole 8c and the first differential pressure regulating valve 41 provided in the discharge hole 8c are quite the same as those of the second embodiment, the same effect can be obtained of course. Further, since the structures of the communication hole 42 formed in the cylinder 2 and the second differential pressure regulating valve 43 provided in the communication hole 42 are quite the same as those of the fifth embodiment, the same effect can be obtained of course.

From the expander of this embodiment having the combination of these structures, the following effect can be obtained.

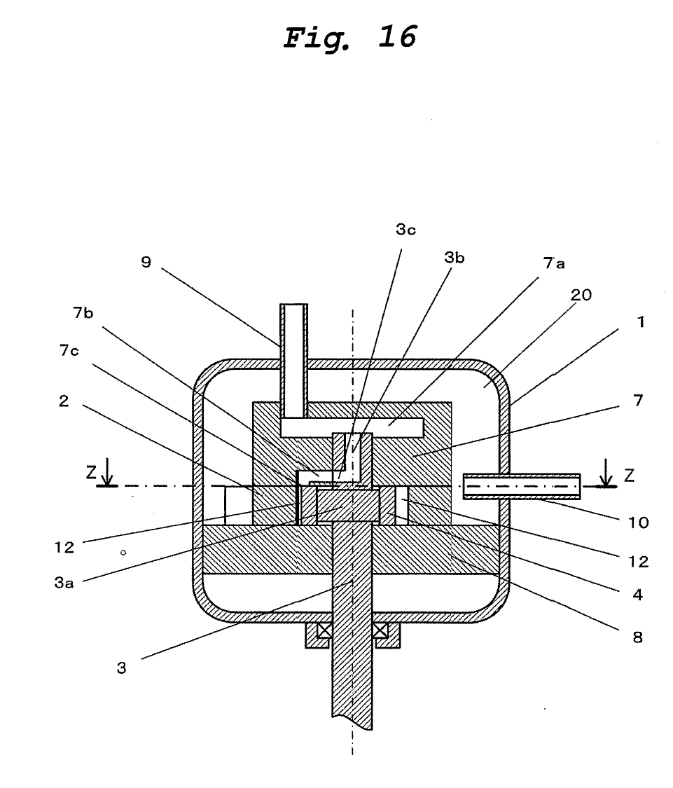

FIG. 15 is a PV diagram of the working chamber 12 of the expander of the seventh embodiment.

Since the communication hole 42 and the second differential pressure regulating valve 43 are provided, immediately after the pressure in the working chamber 12 corresponding to a point F in FIG. 15 becomes equal to a discharge pressure Pl, working fluid flows into the working chamber 12 from the discharge space 20 in an attempt to keep the pressure in the working chamber 12 at the same level as the pressure Pl in the discharge space 20.

However, in the actual case, the working fluid which flowed into the working chamber 12 is not distributed to the entire working chamber 12 due to pressure loss in the communication hole 42 or thin and long shape of the working chamber 12, and the pressure in the working chamber 12 is slightly lower than the pressure Pl in the discharge space 20.

That is, if the reduced pressure at an instant when the expansion stroke is completed is defined as ΔP, the pressure becomes equal to a point I in FIG. 15 when the expansion stroke is completed. The greater the volume of the working chamber 12 is, or the higher the revolution numbers of the expander is, the more remarkably the ΔP appears. Thus, when the discharge hole 8c is not provided with the first differential pressure regulating valve 41, the pressure in the working chamber 12 rises to the pressure Pl of the discharge space 20 at an instant when the working chamber 12 and the discharge hole 8c are brought into communication with each other. Therefore, excessive expansion loss of an area surrounded by FID on the PV diagram in FIG. 15 is generated.

Whereas, according to the expander of this embodiment, since the discharge hole 8c is provided with the first differential pressure regulating valve 41, repressing corresponding to IJ in FIG. 15 is carried out. Thus, according to the expander of this embodiment, FIJ becomes excessive compression loss, and the excessive compression loss is reduced by an area surrounded by IDJ as compared with the structure in which the first differential pressure regulating valve 41 is not provided. Therefore, the efficiency can further be enhanced as compared with the fifth embodiment.

The following effect can be obtained by the expanders of the first to seventh embodiments.

In the case of the conventional expander, when the working fluid is expanded from liquid phase or supercritical phase to gas-liquid two-phase, since the density of the working fluid at the outlet of the expander is largely varied depending upon the dry degree, the pressure ratio of the expander is varied sensitively even if the volume ratio is constant. Therefore, excessive expansion loss and incomplete expansion loss are especially prone to be generated.

Whereas, according to the expanders of the first to seventh embodiments, since the excessive expansion loss and incomplete expansion loss are prevented, it is possible to use working fluid which expands from liquid phase or supercritical phase to gas-liquid two-phase, and the efficient of the expander is enhanced more remarkably.

When working fluid comprising carbon dioxide as main ingredient is used for the conventional expander, since working pressure is high and a pressure difference is great, even if the expansion ratio of the heat pump cycle into which the expander is incorporated is slightly varied, great excessive expansion or incomplete expansion is generated.

Whereas, according to the expanders of the first to seventh embodiments, since the incomplete expansion and excessive expansion are prevented, the invention can be utilized in a heat pump in which an expander for expanding working fluid having carbon dioxide as main ingredient is incorporated, the efficiency of the high pressure can be enhanced more remarkably.

In the expander of this invention, the differential pressure regulating valve which is opened when the pressure in the working chamber becomes higher than that of the discharge space is provided in the discharge hole. Since repressing can be carried out even when excessive expansion is generated, the excessive expansion loss can be prevented. In addition, if the volume ratio of the expander is previously set sufficiently great so that incomplete expansion is not generated, it is possible to provide an efficient expander which does not generate incomplete expansion loss and excessive expansion loss under any conditions.

According to the present invention, the expander is provided with the communication hole which brings the working chamber and the discharge space into communication, and the communication hole is provided with the differential pressure regulating valve which is opened when the pressure in the working chamber becomes lower than that of the discharge space. Therefore, if the pressure in the working chamber becomes lower than that of the discharge space, the working fluid flows into the working chamber from the discharge space, the pressure in the working chamber becomes equal to the pressure in the discharge space and thus, the excessive expansion can be prevented. In addition, if the volume ratio of the expander is previously set sufficiently great so that incomplete expansion is not generated, it is possible to provide an efficient expander which does not generate incomplete expansion loss and excessive expansion loss under any conditions.

### INDUSTRIAL APPLICABILITY

The expander of the present invention can be utilized as a prime motor or a power generator which obtains rotation power from compressible gas.

1-7. (canceled)

8. An expander comprising a cylinder, a shaft having an eccentric portion, a roller which is fitted to said eccentric portion and which eccentrically rotates inside said cylinder, a closing member for closing both end surfaces of said cylinder, a vane for partitioning a space formed by said cylinder, said roller and said closing member into a plurality of working chambers, a suction hole through which working fluid flows into said working chamber, and a discharge hole through which the working fluid is discharged from said working chamber into a discharge space, wherein said discharge hole is provided with a differential pressure regulating valve which is operated by a difference between pressure in said working chamber and pressure in said discharge space.

9. The expander according to claim 8, wherein said differential pressure regulating valve is closed when the pressure in said working chamber is lower than the pressure in said discharge space.

10. The expander according to claim 9, wherein said differential pressure regulating valve is a reed valve.

11. The expander according to claim 9, wherein said differential pressure regulating valve has a circular conical valve portion.

12. The expander according to claim 8, wherein fluid which expands from liquid phase or supercritical phase to gas-liquid two-phase is used as the working fluid.

13. The expander according to claim 12, wherein the expander is utilized in a heat pump cycle which uses carbon dioxide as the working fluid.

14. The expander according to claim 13, wherein a shaft of said expander is directly connected to a shaft of a compressor.

15. The expander according to claim 9, wherein fluid which expands from liquid phase or supercritical phase to gas-liquid two-phase is used as the working fluid.

16. The expander according to claim 10, wherein fluid which expands from liquid phase or supercritical phase to gas-liquid two-phase is used as the working fluid.

17. The expander according to claim 11, wherein fluid which expands from liquid phase or supercritical phase to gas-liquid two-phase is used as the working fluid.

18. The expander according to claim 15, wherein the expander is utilized in a heat pump cycle which uses carbon dioxide as the working fluid.

19. The expander according to claim 16, wherein the expander is utilized in a heat pump cycle which uses carbon dioxide as the working fluid.

20. The expander according to claim 17, wherein the expander is utilized in a heat pump cycle which uses carbon dioxide as the working fluid.

21. The expander according to claim 18, wherein a shaft of said expander is directly connected to a shaft of a compressor.

22. The expander according to claim 19, wherein a shaft of said expander is directly connected to a shaft of a compressor.

23. The expander according to claim 20, wherein a shaft of said expander is directly connected to a shaft of a compressor.
